(19) United States
(12) Patent Application Publication
(10) Pub. No.: US 2020/0258178 A1
(43) Pub. Date: Aug. 13, 2020

(54) Triggering of Incident Report Record Generation in a Controlled Facility

(71) Applicant: Securus Technologies, Inc., Dallas, TX (US)

(72) Inventors: Luke Keiser, Frisco, TX (US); Chandra Jonelagadda, West Windsor, NJ (US)

(73) Assignee: SECURUS TECHNOLOGIES, INC., Dallas, TX (US)

(21) Appl. No.: 14/176,114

(22) Filed: Feb. 9, 2014

(51) Int. Cl. G06Q 50/26; G06Q 10/00

(52) U.S. Cl. CPC G06Q 50/26; G06Q 10/00

(57) ABSTRACT

Embodiments of systems and methods for triggering of incident report record generating in a controlled facility are described. The incidents may involve acts of sexual misconduct. An embodiment of a system includes one or more communication devices in electronic communication with a crime reporting server. The system may also include a crime reporting server coupled to the one or more communication devices. The crime reporting server may be configured to receive information concerning an inmate in a controlled facility over a facility communications system that is related to an act of sexual misconduct, automatically trigger an event in response to receiving the information, and generate a record comprising at least a portion of the information related to the act of sexual misconduct in a data storage device.

### BACKGROUND

Sexual victimization, as defined by Justice Department's Bureau of Justice Statistics (BJS), in compliance with the Prison Rape Elimination Act of 2003, involves both inmate-on-inmate and staff-on-inmate sexual victimization. Inmate-on-inmate sexual victimization includes nonconsensual sexual acts (involving penetration) and abusive sexual contacts (involving sexual touching without an inmate's consent). Staff-on-inmate sexual victimization includes sexual misconduct (involving any behavior or act of a sexual nature directed toward an inmate by staff) and sexual harassment (involving repeated verbal statements or comments of a sexual nature to an inmate by staff).

More than half of all substantiated incidents were perpetrated by another inmate. More than fifty percent of these incidents involved nonconsensual sexual acts. Among all substantiated incidents of inmate-on-inmate sexual victimization, 69 percent involved force or threat of force, offers of protection or favors, bribery, blackmail or other types of pressure.

Staff was involved in 939 incidents of sexual misconduct or harassment (515 in 2007 and 424 in 2008). In more than 60 percent of the incidents, the sexual relationship between staff and inmate “appeared willing” although inmates by law are unable to consent. The majority of incidents involved staff sexual misconduct.

In response to such statistics, federal, state and local governments may enact laws, rules, and regulations to reduce sexual misconduct in controlled facilities. One such act is the Prison Rape Elimination Act of 2003, which requires controlled facilities to comply with certain standards and to provide evidence of compliance with such standards.

### SUMMARY

The various techniques described herein may find applicability in a wide variety of controlled-environment facilities (as well as outside of controlled-environment facilities). Examples of controlled-environment facilities may include correctional institutions or facilities (e.g., municipal jails, county jails, state prisons, federal prisons, military stockades, juvenile facilities, detention camps, home incarceration environments, etc.), healthcare facilities (e.g., hospitals, nursing homes, mental health facilities, rehabilitation clinics, such as drug and alcohol rehabilitation facilities, etc.), restricted living quarters (e.g., hotels, resorts, camps, dormitories, barracks, etc.), and the like.

The present embodiments describe methods and systems for handling reporting of acts of sexual misconduct, including generation of reports and records used for investigation and compliance purposes. In one embodiment, the systems and methods include receiving a report of an act of sexual misconduct via a communication system associated with a controlled facility. For example, an inmate may report an act of sexual misconduct involving himself or another inmate using a telephone or video visitation system installed within the controlled facility. Staff may also report an incident using such a system, or outside access to the system. Third-parties may also access the system to report suspicions of an act of sexual misconduct.

In an embodiment, the method includes receiving, at a crime server, information concerning an inmate in a supervised manner over a facility communications system that is related to an act of sexual misconduct. The method may also include triggering an event in response to receiving the information. Additionally, the method may include generating a record comprising at least a portion of the information related to the act of sexual misconduct in a data storage device.

In an embodiment, the method may include receiving the information from a party of the incident, a staff member, or 3rd party via an interface. The interface comprises one of a video visitation system, a telephone communication system, an email communication system, a kiosk communication system, or an access point utilized by a staff member or 3rd party.

In an embodiment, the method may also include providing accessibility services to a party reporting the act of sexual misconduct. Providing the accessibility services may include providing a language selection control to the party reporting the act of sexual misconduct. In an embodiment, the method may also include providing translation services in response to a language selection via the language selection control. In another embodiment, the method may include providing interpretation services in response to a language selection via the language selection control. In still another embodiment, the method includes providing accessibility services further comprises providing accommodations for a party with a physical impairment.

In an embodiment, the method may also include determining whether the act of sexual misconduct requires emergency response, generating a report to an emergency responder requesting assistance at the scene of the incident. The method may also include determining whether the act of sexual misconduct warrants initiation of an investigation, and generating a report to an investigator requesting investigation of the act of sexual misconduct. In an embodiment, the method may include a delay or automatic response to the triggering event.

In certain embodiments, the sexual misconduct may occur the current controlled environment, a previously controlled environment, or while under the supervision of a supervisor.

In still a further embodiment, the method may include determining whether administrative action is required in response to the report of the act of sexual misconduct, and generating a report to an administrator requesting action in response to the act of sexual misconduct. The action may include conducting a physical transfer of the victim of the act of sexual misconduct to a new location. Alternatively, the action may include removing or reassigning the staff from the victim. In still another embodiment, the action may include investigation of staff of the controlled facility.

In an embodiment, the method may also include determining whether the act of sexual misconduct involves a juvenile, and generating a report to a juvenile services organization to report the act of sexual misconduct.

In an embodiment, the method may include automatically scheduling one or more response deadlines in response to the time at which the event is triggered. In an embodiment, the method may include requiring a responsive communication in response to the triggered event, and escalating the event to a superior in response to a determination that the responsive communication has not been received by the response deadline. Additionally, the method may include storing the information received in a secure storage device. The method may also include protecting the anonymity of a party involved in the incident, the nature of the reporting or reporting of the incident in response to a request for anonymity.

A tangible computer readable medium comprising processor-executable code is also presented. In an embodiment, when executed by a processor, the processor-executable code may cause the processor to perform certain operations. In an embodiment, the operations may include receiving, at a crime server, information concerning an inmate in a controlled facility over a facility communications system that is related to an act of sexual misconduct, automatically triggering an event in response to receiving the information, and generating a record comprising at least a portion of the information related to the act of sexual misconduct in a data storage device.

Embodiments of a system are also presented. In an embodiment, the system may include one or more communication devices in electronic communication with a crime reporting server, and a crime reporting server coupled to the one or more communication devices. In an embodiment, the crime server may be configured to receive information concerning an inmate in a controlled facility over a facility communications system that is related to an act of sexual misconduct, trigger an event in response to receiving the information, and generate a record comprising at least a portion of the information related to the act of sexual misconduct in a data storage device.

### BRIEF DESCRIPTION OF THE DRAWINGS

Having thus described the invention in general terms, reference will now be made to the accompanying drawings, which are not necessarily drawn to scale, and wherein:

FIG. 1 is a high-level block diagram of a communications system that facilitates communications between an inmate and other parties.

FIG. 2 is a schematic block diagram illustrating one embodiment of a crime server.

FIG. 3 is a schematic block diagram illustrating another embodiment of a crime server.

FIG. 4 is a schematic flowchart diagram illustrating one embodiment of a method for triggering a record of a PREA incident.

FIG. 5 is a schematic flowchart diagram illustrating another embodiment of a method for triggering a record of a PREA incident.

FIG. 6 is a schematic flowchart diagram illustrating one embodiment of a method for providing accessibility to a party reporting an act of misconduct.

FIG. 7 is a schematic block diagram illustrating one embodiment of a computer system configured for use according to the present embodiments.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The present embodiments describe methods and systems for handling reporting of acts of crimes, sexual misconduct, and other misconduct. The methods and systems include generation of reports and records used for investigation and compliance purposes. In one embodiment, the systems and methods include receiving a report of an act of sexual misconduct via a communication system associated with a controlled facility. For example, an inmate may report an act of sexual misconduct involving himself or another inmate using a telephone or video visitation system installed within the controlled facility. Staff may also report an incident using such a system, or outside access to the system. Third-parties may also access the system to report suspicions of an act of sexual misconduct.

Beneficially, such embodiments may provide inmates the ability to covertly report a crime or act of sexual misconduct, such that anonymity is maintained. An additional benefit is that evidence obtained during the reporting of the act may be recorded and preserved for investigation and/or prosecution of parties involved. Furthermore, certain actions involved in generation of records may be simplified or automated according to aspects of the present embodiments. Still further benefits include simplification of compliance assurance, administrative review, and document/data production.

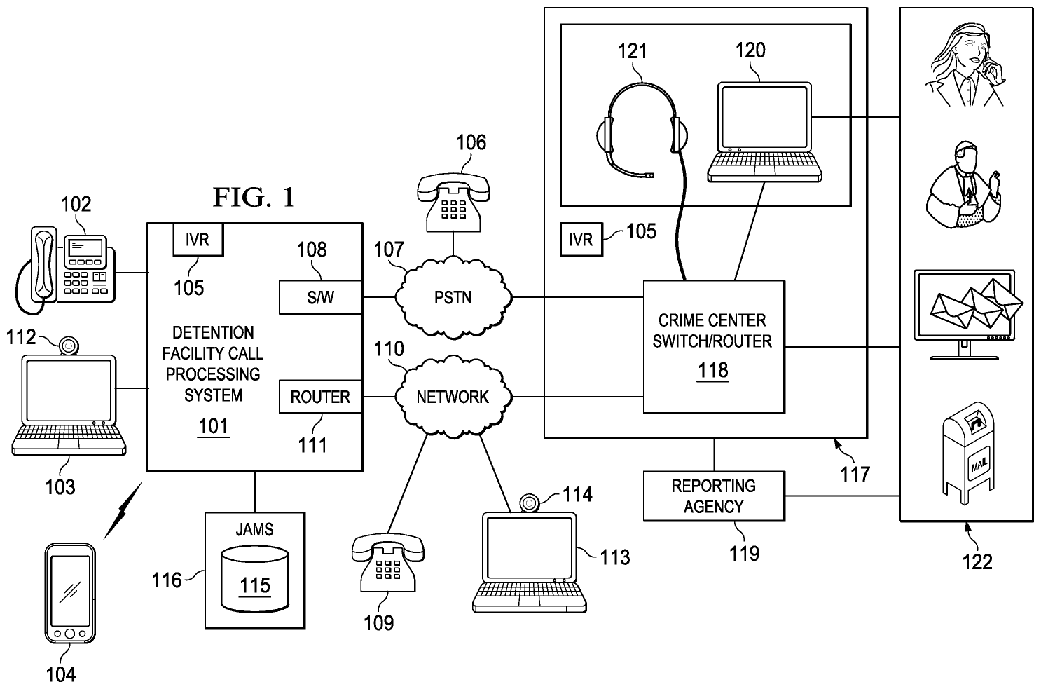

FIG. 1 is a high-level block diagram of a communications system that facilitates communications between an inmate and other parties. Communications system 101 provides telephone services to one or more correctional facilities, such as a prison, jail, detention facility, boot camp, labor camp, other reformatory, or other penitentiary. Call processing system 101 may be located at a particular correctional facility for which it provides calling services. Alternatively, call processing system 101 may be centrally or remotely located with respect to one or more correctional facilities and may provide calling services to multiple correctional facilities. In particular, call processing system 101 provides telephone services to inmates, prisoners, detainees, arrestees or other individuals that are restricted to and a resident of the correctional facility.

Inmates use telephone 102 to access telephone services. In some facilities, inmates may also use a personal computer or kiosk 103 or wireless device 104 to access telephone services. An inmate initiates telephone services by using one of the telephone 102, the kiosk 103, or the wireless device 104. At that time, the inmate may be prompted to provide a personal identification number (PIN), other identifying information or biometrics. Call processing system 101 may include an interactive voice response (IVR) unit 105 that generates and plays prompts or other messages to inmates on the device-in-use, 102, 103, or 104.

Under the control of call processing system 101, the device-in-use 102, 103, or 104 may be connected to friends and family at telephone 106 across a publicly switched telephone network (PSTN) 107. Telephone 106 may be located at a home, inmate visitation center, or other facility. Switch 108 in call processing system 101 is used to connect calls across PSTN 107.

In an alternative arrangement, the inmate's friends and family may be at telephone 109, which is on a Voice over IP (VoIP) or packet data network 110. Router 111 in call processing system 101 is used to route data packets associated with a call connection to destination telephone 109. The terms switch and router are intended to be used as interchangeable herein. The terms switch and router as used in the description of the call center system are both intended to cover a device that connects circuit-switched and packet-switched telephone call connections.

The inmate and called party may also communicate via video call. Computer or kiosk 103 may have a camera 112, and a called party may have a personal or laptop computer 113 with a camera 114. The video call connection between the parties may be established and supported by an organization or commercial service that provides computer services and software for use in telecommunications and VOIP, such as SKYPE®. Alternatively, the correctional facility and the destination may use H323 videoconferencing equipment.

Call processing system 101 ensures that the inmate's calls are connected only to numbers on an approved Personal Allowed Numbers (PAN) list. Each inmate's PAN list may be stored, for example, in an inmate profile in a database 115. The PAN list and other inmate profile data may be maintained by a jail administration and management system (JAMS) 116. The inmate profile data may include balances for inmate trust and calling accounts; trial schedules; conviction data; criminal records; sentencing data, such as time served, time remaining to be served, and release dates; cell and cellmate assignments; inmate restrictions and warnings; order history; telephone call history; call recordings; known or suspected gang or criminal affiliations; known or suspected affiliates, accomplices, or gang members; and any other information that is relevant or useful to correctional facility staff to house and maintain inmates.

In one embodiment, inmates may use the device-in-use, 102, 103, or 104, to report a crime. The crime may be in the past, in the future, or on-going. The crime may be against the inmate or the inmate may be a witness or otherwise have information regarding a crime against another inmate. The crime is reported via crime reporting server 117. Note that although server 117 is shown to be separate from system 101, the server may be incorporated within the system 101. The server 117 may be located at the correctional facility or remote from the facility. If the server 117 is remote from the correctional facility, this may provide more anonymity for the crime report if the facility staff is involved in the crime. The server 117 may serve one or more facilities and may be operated by the correctional facility itself or by a commercial vendor.

In any event, inmates may access sever 117 using device-in-use 102, 103, or 104. An inmate logs-in using a PIN or identifier associated with his or her account. In one embodiment, the server 117 is reached by calling a dedicated phone number or access number. This dedicated number may be automatically listed on every inmate's PAN list or on a non-restricted list. This would allow the dedicated line to be open to allow inmates access to report information.

In another embodiment, the server 117 is selected by the inmate during a call sequence. The system 101 would provide a list of choices to the inmate. One of the choices is to report a crime, whereby the system 101 then connects the inmate to the server 117. For example, if the device-in-use is a telephone 102,104, then using IVR 105, the inmate may be presented with a list, e.g. press 1 to make a call charged to your account, press 2 to make a collect call, . . . and press 9 to report a crime. As another example, if the device-in-use is a kiosk 103, then the user may be presented with a GUI interface, with buttons that are labeled “make a call charged to your account”, “make a collect call”, . . . and “report a crime”. The list of items provided to the inmate may be selected based upon data stored in the inmate's profile on JAMS database 115. The crime reporting choice may be automatically listed on every inmate's profile on the JAMS database or not on a restricted list. This embodiment allows an inmate to report a crime without having to know the crime reporting number and is not seen by other inmates dialing the number.

In another embodiment, the server 117 is selected by the inmate from a general interface or an interface that has a function other than crime reporting. For example, the interface may allow the inmate to order goods and services. An additional choice for the inmate is to report a crime. For example, if the device-in-use is a telephone 102-104, then using IVR 105, the inmate may be presented with a list, e.g. press 1 to order cigarettes, press 2 to order candy, . . . and press 9 to report a crime. As another example, if the device-in-use is a kiosk 103, then the user may be presented with a GUI interface, with buttons that are labeled “cigarettes,” “candy,” . . . and “report a crime.” The list of items provided to the inmate may be selected based upon data stored in the inmate's profile on JAMS database 115. The crime reporting choice may be automatically listed on every inmate's profile on the JAMS database or not on a restricted list. This embodiment allows an inmate to report a crime without having to know the crime reporting number and is not seen by other inmates dialing the number.

After connecting the inmate to the server 117, the server handles the crime reporting. In one embodiment, the server 117 records the crime report via computer 120, which is then investigated by an investigating entity. The investigating entity may be associated with the correctional facility, may be an agency of the government, or may be a private company contracted to perform investigation.

In another embodiment, the server 117 connects inmates to live agents 121. In this embodiment, the server 117 uses switch/router 118 to connect the inmate to an available agent 121. The agent may be a scribe that records information such as the type of crime, date of crime, place of crime, involved parties, etc. The agent may be a counselor that records information, and treats the inmate. The agent may be an investigating officer that records the information and begins the investigation with this contact. The agent may use a telephone, a workstation, display screen, or combinations thereof to communicate with the inmate. Any number of agents 121 may be supported by the switch/router 118. The agents 121 may be physically located in one or more designated call center facilities. Alternatively, some or all of the agents may work from separate locations, such as their home. The switch/router 118 may treat the remote agents as part of a virtual call center by distributing incoming inmate calls as if all the operators were at co-located. The computer 120 may be used to record information if all agents are busy.

If the agents are live agents, the inmate may be provided a message that the contact will be monitored, and/or a warning that the call will be terminated if any offensive conduct occurs and such. Because inmates are typically not allowed to speak with people outside the prison other than the limited group on an approved PAN list, the inmate may try to keep talking to the agent without reporting a crime. The agent may terminate the contact in such a case.

Another embodiment may use both the live agent 121 and the computer 120. This would allow different crimes to be handled differently. For example, lesser crimes such as theft or bulling may be recorded by the computer 120, while greater crimes such as murder, attempted murder, and rape may be handled by a live agent 121. The server determines which entity will handle the crime report based on information provided by the inmate during the contact. For example, a list of crimes may be provided to the inmate. Crimes that have already occurred may be recorded, while future crimes and on-going crimes may be handled by a live agent. Inmates that have previously reported false crimes, or wasted agent time with non-crime contacts may have their contacts recorded by computer instead of being handled by a live agent. The inmate's profile may be updated to indicate that the inmate is a habitual false reporter, and thus automatically handed to the computer 120.

In another embodiment, the first contact by the inmate may be recorded by the computer 120. Subsequent contacts by the inmate regarding the same crime may be handled by the live agent 121. This would allow for some investigation of the crime to occur before the agent speaks with the inmate. If the agent is a counselor, then the inmate may be provided treatment for the crime with later calls.

In another embodiment, different live agents are connected with the inmate at different times. For example, during initial stages of the investigation, the inmate may be connected with an investigating agent. If the investigating agent determines that a crime did occur, and the crime requires treatment (e.g., a rape), then a counselor agent may be connected with the inmate.

In another embodiment, after the inmate selects to report a crime, the inmate may proceed with another activity, such as making a telephone call that is recorded by the computer 120 or monitored by the agent 121. In this case, information is passed to the server 117 by having the inmate communicate with a third party, such as a family member or attorney.

In another embodiment, the server 117 reports the crime to a reporting agency. Some types of crimes are required to be reported to government agencies. For example, under the Prison Rape Elimination Act of 2003, rapes occurring in federal prisons should be reported to the Department of Justice. In such a case, the server 117 would initiate a report to the proper reporting agency or agencies. The report may be sent when the initial crime is reported by the inmate. Updates may be sent as further information is uncovered during the investigation. Alternatively, a report may be sent when the investigation is complete.

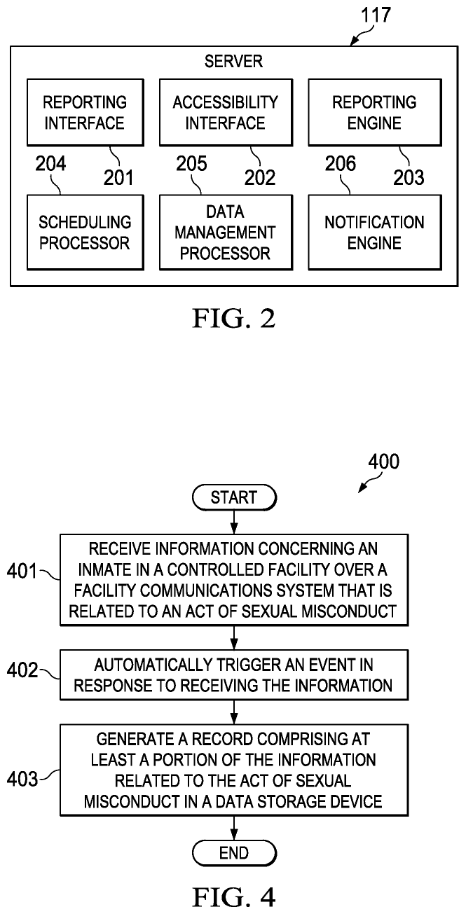

FIG. 2 illustrates an embodiment of the server 117. In an embodiment, the server 117 may include one or more components, such as a reporting interface 201, an accessibility interface 202, a reporting engine 203, a scheduling processor 204, a data management processor 205, and a notification engine 206. The server 117 may be thus configured to receive reports of crimes involving sexual misconduct and other sexual abuse. The server 117 may a trigger recording and reporting function in response to the reports of sexual misconduct for investigation and protection against further misconduct, and the like.

In one embodiment, the reporting interface 201 may be configured to receive a report of a crime or other sexual abuse from, e.g., an inmate, facility staff, or a third-party. The report may include voice data received over a telephone 102, 106, 109, video data received via a kiosk 103 or other video capture device 112, a computing device 113 or the like. In a further embodiment, the report may include text data or menu selections entered via a computing device, tablet device such as wireless device 104, kiosk 103, or the like. In certain embodiments, the reporting interface 201 may be configured to covertly receive reporting information, without the knowledge of any inmate of the facility. For example, the reporting interface 201 may be coupled to a telephone or conferencing system, and may receive reporting information from a call monitoring device or live agent monitoring a conversation that may include information concerning a PREA event.

In an embodiment, the accessibility interface 202 may be coupled to the reporting interface 201. The accessibility interface 202 may provide access accommodations for users with disabilities, such as hearing impairment, vision impairment, psychological impairment, mental impairment, or the like. In another embodiment, the accessibility interface 202 may provide language accommodations for non-English speaking users.

Reporting engine 203 may be coupled to reporting interface 201 and may use information obtained via reporting interface to trigger generating of an incident record or report. In one embodiment, reporting engine 203 may use IVR 105 to record the information obtained via reporting interface 201. In a further embodiment, the recording may be presented by the reporting engine 203 to a live agent, along with a selection of pre-defined forms for generating the record in response to the information. In another embodiment, the reporting engine 203 may employ speech-to-text utility to generate a transcript of the information received via the reporting interface 201.

In still a further embodiment, the reporting engine 203 may automatically generate a report from speech or text inputs received by the reporting interface 201 in response to a set of predefined information prompts. For example, the reporting interface 201 may include a field labeled “Name:” for prompting the user to enter his/her name. In another embodiment, the reporting interface 201 may present the user with an audio prompt requesting the user to enter his or her name. In such an embodiment, a speech-to-text utility may be used to record the name information provided by the user and the reporting engine 203 may use the name information to auto-populate a field in a report.

In an embodiment, scheduling processor 204 may be coupled to the reporting engine 203 and/or the reporting interface 201. In such an embodiment, the scheduling processor 204 may generate a time stamp associated with the time a report is received via the reporting interface 201. The scheduling processor 204 may then communicate the time stamp to the reporting engine 203 for inclusion in the report. In a further embodiment, the scheduling processor 204 may automatically generate scheduling events associated with certain predetermined action deadlines.

For example, the scheduling processor 204 may schedule immediate review of the grievance by an available and/or appropriate authority or agent. In such an embodiment, scheduling processor 204 may consult a scheduling utility to determine which authority or agent is available to review the report. In a further embodiment, the scheduling processor 204 may ensure that the scheduled authority or agent is not identified as a party directly involved in the report, i.e., the perpetrator, victim, or reporter.

In still a further embodiment, the scheduling processor 204 may record a deadline or schedule for providing an initial response to the report. For example, the scheduling processor 204 may provide means for allowing an investigator to acknowledge the report, provide investigation progress updates, or the like. In another embodiment, the scheduling processor 204 may schedule a deadline for providing a completed final agency decision, for example within five days of receiving the report. In an embodiment, these updates may be provided to the person who reported the incident, to facility management, or the like. Additionally, the scheduling processor 204 may trigger notifications from the notification engine 206 to the assigned authority or agent as the deadline or scheduled event draws near.

The data management processor 205 may handle storage and organization of records and associated files on a data storage device. For example, the data management processor 205 may store a record or set of records in a database associated with each reported incident. In still a further embodiment, the data management processor 205 may also attach voice data files, text files, video files, and other media obtained during the reporting and investigation of an incident in association with the record. In some embodiments, the data management processor 205 may be configured to store and produce such records and associated files or data as evidence in an investigation, administrative review, judicial proceeding, or the like. The data management processor 205 may be further configured to store communications, such as notifications generated by the notification engine 206 in association with the record.

The notification engine 206 may be coupled to the reporting engine 203, the scheduling processor 204, and/or the data management processor 205 and configured to automatically generate notifications, including written notifications, to parties involved in a reported incident. For example, the notification engine 205 may generate an email, telephone message, text message, or the like indicating an assignment of a new incident for investigation to an investigating agent and/or to a PREA coordinator for the facility. The notification engine 205 may additionally provide written notifications, either by email or for mailing through postal services, for notifying the victim that an investigation is underway, that the investigation is complete, and that a final decision on the investigation has been reached. In still further embodiments, the notification engine 205 may notify a subject of an investigation that they are being investigated for a report of sexual misconduct. One of ordinary skill will recognize additional notifications that may be automatically generated, including automatic notification of administrative agencies for record keeping and auditing purposes, etc.

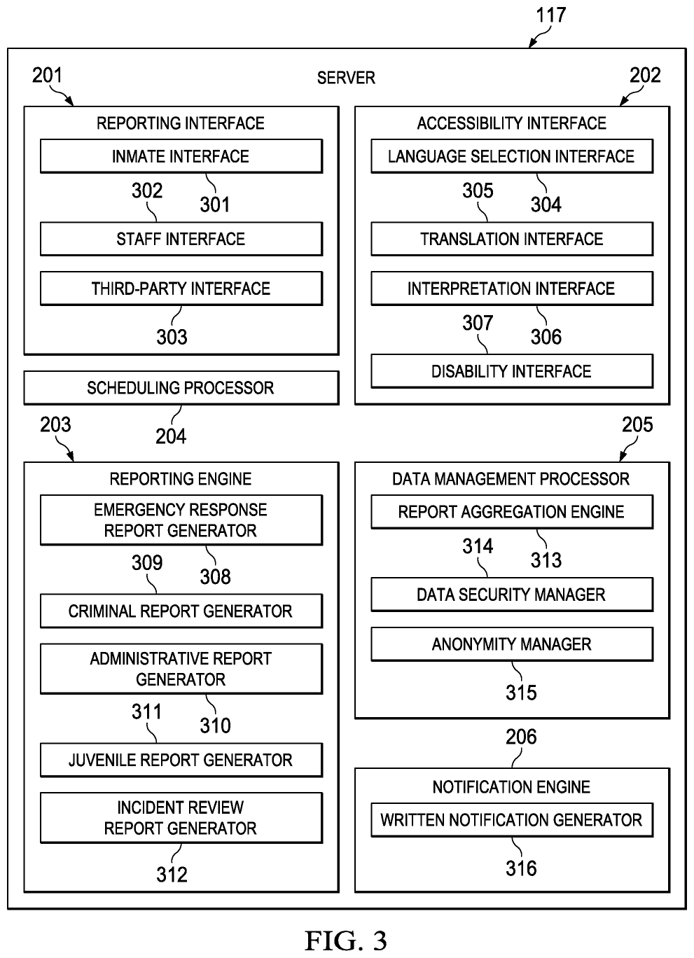

FIG. 3 illustrates another embodiment of a server 117. In this embodiment, the server 117 may also include the reporting interface 201, the accessibility interface 202, the reporting engine 203, the scheduling processor 204, the data management processor 205, and/or the notification engine 206 substantially as described above with relation to FIG. 2. In addition, these units may include additional units, which may be arranged as sub-units or co-units.

For example, the reporting interface 201 may include one or more of an inmate interface 301, a staff interface 302, and a third-party interface 303. The inmate interface 301 may be coupled to a communication device 102-104 disposed within a secure facility and designated for use by inmates. The inmate interface 301 may provide prompts for inmate-specific information, including prompts for the inmate to provide a PIN or other identifier. In certain embodiments, the inmate interface 301 may also be configured to allow an inmate to make an anonymous report.

The staff interface 302 may be coupled to a communication device 102-104 located within the secure facility, or to an external communication device, such as telephone 106 or communication devices 109, 113, or any wired or wireless device or multi-model device. In an embodiment, the staff interface 302 may prompt entry of identification information, such as an employee identification number, badge number, PIN, or the like.

In one embodiment, the reporting interface 201 may include a third-party interface 303. In such an embodiment, the third-party interface 303 may be coupled to an external communication device (e.g., communication device 106, 109 or 113). In another embodiment, the third-party interface 303 may include an Internet-accessible web page. In such an embodiment, the third-party interface may provide an option for allowing a third-party, such as a relative, friend, counselor, attorney, or other associate of an inmate to initiate a report of a crime or of sexual misconduct. For example, during the course of a visitation call an inmate may confide in a friend or family member that they are being sexually abused in the facility. In one embodiment, the third-party may be given an opportunity to report a crime or sexual misconduct via the third-party interface.

In a further embodiment, the accessibility interface 202 may include one or more interfaces including a language selection interface 304, a translation interface 305, an interpretation interface 306, and/or a disability interface. These additional interfaces 304-307 may enhance the ability of the accessibility interface 202 to meet specific needs of inmates who would otherwise have difficulty reporting a crime and/or sexual misconduct due to language or disability barriers.

In an embodiment, the language selection interface 304 may prompt the inmate to indicate his or her primary language. For example, the language selection interface 304 may provide a series of voice prompts in a selection of languages for allowing a user to select a language for communication via a touch-tone key entry. In another embodiment, the language selection interface 304 may provide a selectable menu or text entry field for allowing a user to select his or her primary language.

Upon entry of a selection in the language selection interface 304, the accessibility interface 202 may provide commands and menu options in the selected language. Additionally, the accessibility interface 202 may provide additional language services, including translation and/or interpretation.

For example, the translation interface 305 may provide the user with menu selections that have been translated into his or her selected language. In a further embodiment, the translation interface may provide the English commands, information, and menu selections as well as a translation of the English commands, information, and menu selections. In a further embodiment, the translation interface 305 may provide a language-specific text or character entry utility, such as a touch-screen selectable keyboard, for allowing the user to enter information in the selected language. In still a further embodiment, the translation interface 305 may automatically translate menu selections and/or entered text from the selected language into English for inclusion in the incident report.

In certain embodiments, it may be useful to provide interpretation services to the user. For example, if the user is calling from a PSTN-based telephone 106, it may be necessary to connect the user to a live agent 121 for interpretation of both information provided to the user and information received from the user. In such an embodiment, the interpretation interface 306 may connect the user with a live agent via crime center switch/router 118. The live agent 121 may use computer 120 to enter information received from the user. In still a further embodiment, the interpretation interface 306 may provide pre-recorded translations of information meant for the user. The IVR 105 may record the information provided by the user for interpretation at a later time, e.g., by a court or agency certified interpreter.

Language differences may not be the only barrier hindering efficient collection of information related to an incident. For example, users with physical or mental impairments may have difficulty communicating information via standard systems. In such an embodiment, the disability interface 307 may provide accommodations for assisting users having various physical or mental impairments. In certain embodiments, disability interface 307 may provide and obtain information via specialized systems, such as a Telecommunications Device for the Deaf (TDD) a text-to-speech converter, a speech-to-text converter, or the like. The disability interface 307 may provide the user with a selectable font size for enhancement of the readability of menu items and other information provided during the recordation process. In still further embodiments, the disability interface 307 may connect the user to a live agent, such as an operator, investigator, or counselor for assisting the user with recording the incident or grievance.

In an embodiment, the reporting engine 203 may further include an emergency response report generator 308, a criminal report generator 309, an administrative report generator 310, a juvenile report generator 311, and/or an incident review report generator 312. These additional units may be configured to generate specialized reports for various emergency response personnel, administrative agencies, facility administrators or coordinators, and/or federal, state or local government organizations.

For example, the emergency response report generator 308 may be configured to generate an emergency response request in response to a determination that the inmate is in need of immediate protection and/or medical examination. The emergency response request may include information obtained via the reporting interface 201, including for example, the name and location of the inmate, the nature of the incident, the time at which the incident is occurring, and the type of emergency response required.

If it is determined that the incident is criminal in nature, a criminal report may be generated by the criminal report generator 310 and communicated to a criminal investigation team, criminal prosecutors, local police authorities, or the like. In an embodiment, the criminal report may include information gathered by the reporting interface 201. The criminal report may also be linked to a recording or transcript of the incident report obtained by the reporting interface 201. By way of example, an inmate may call in using voice and video capabilities of kiosk 103 to report that he has been the victim of sexual abuse in a prison facility. In one embodiment, the criminal report generator 309 may link the video and audio file, along with any text or menu selections entered by the inmate to the criminal report and mark them as evidence for the criminal investigation via the criminal report generator 309. In a further embodiment, an investigator may access the criminal report generator 309 to update a criminal report generated in response to the call. For example, the investigator may record findings from examination of the victim and/or the scene of the incident. The investigator may further record a description or identification of physical evidence collected at the scene.

In one embodiment, the reporting engine 203 may include an administrative report generator 310. The administrative report generator 310 may generate a report to administration of the secure facility, PREA review boards, governmental administrative bodies such as the Department of Justice, or the like. In one embodiment, the administrative report generator 310 may generate a report of the incident and handling of the inmate in response to the incident. In a further embodiment, the administrative report generator 310 may generate a record of compliance with laws, rules, and regulations concerning handling of reports of crimes or abuse under state and federal laws, such as PREA. In an embodiment, the administrative report generator 310 may attach or otherwise link to recordings or transcripts of the original report received by the reporting interface 201. In an embodiment, the report generator 310 may automatically populate or generate one or more forms required by a government agency, such as the Bureau of Justice, for reporting PREA events.

If a reported victim of sexual misconduct is under the age of eighteen or considered a vulnerable adult, the facility may be required to report the incident to state or local services. For example, the juvenile report generator 311 may automatically generate a report to child protective services, or other designated service organizations in response to a determination that the victim is under the age of eighteen. In another embodiment the juvenile report generator 311 may also generate reports to social services in response to a determination that the victim is mentally impaired, emotionally impaired, or elderly and exhibiting loss of physical or mental faculties. In an embodiment, the juvenile report generator 311 may attach or otherwise link to recordings or transcripts of the original report received by the reporting interface 201.

Upon conclusion of the investigation of each incident, an incident review board or incident review team may review actions taken during the course of the investigation to ensure compliance with state and federal requirements. The incident review report generator 312 may automatically generate a summary report that condenses information obtained during the course of the investigation, including information obtained by the reporting interface 201 during the initial report of the incident. In an embodiment, the incident review report generator 312 may include links to transcripts or recordings of the initial report received by the reporting interface 201.

In one embodiment, the data management processor 205 may include a report aggregation engine 313, a data security manager 314, and an anonymity manager 315. These units of the data management processor 205 may be configured to maintain a level of data security and confidentiality that meets federal and state security and privacy requirements. For example, the data management processor 205 may ensure compliance with PREA data handling requirements, etc.

In an embodiment, the report aggregation engine 313 may be configured to aggregate information in a selection of records generated within a specified time period. The time period may be predetermined or selectable. In one embodiment, the aggregation engine 313 may collect all data obtained or otherwise generated during the previous calendar year and provide such data to a requesting organization, such as the Department of Justice or a judicial body, within a specified time period. In one embodiment, the report aggregation engine 313 may redact certain portions of the data for security or privacy considerations. In still a further embodiment, the report aggregation engine 313 may aggregate recordings or transcripts of reports received via reporting interface 201 in combination with criminal, administrative, and other report records stored in a data storage device.

Data security requirements may also be imposed by federal or state laws, rules, and regulations. In such an embodiment, the data security manager 314 may enforce a data security policy. The data security policy may, for example, specify encryption of drives on which the reports, records, recordings, and transcripts are stored. Additionally, the data security manager 314 may require authorization credentials to be entered prior to granting access to sensitive data. In still further embodiments, the data security manager 314 may enforce a permissions policy that, for example, allows a first set of users to access the data in a read only fashion, while allowing other users to update or modify the data. For example, according to one embodiment, a PREA coordinator and an assigned investigator may be given permission to update records, but prison administration and the PREA review team may only be given permission to read and review the data.

In an embodiment, the data management processor 205 may include an anonymity manager 315 configured to implement anonymity measures for protecting the identity of certain parties involved in a reported incident. For example, it may be necessary to guard the identity of a victim or third-party reporting an incident in order to avoid possible retaliation for reporting of the crime. In such an embodiment, the names and other identifying information such as PIN, cell or room number, etc. may be redacted from certain reports or may be blocked from viewing except by designated individuals with permission to view the private information.

In an embodiment, the notification engine 206 may further include a written notification generator 316 configured to automatically generate written communications to parties involved in the reported incident. Written communications may include form letters, automatically populated template letters, templates for communications to be filled in by a live agent 121, email notifications, etc.

In a further embodiment, the server 117 may include a dashboard generator 318 configured to generate a dashboard interface. The dashboard interface may include an application interface or a web interface. The dashboard interface may be configured to provide a snapshot of compiled information used for managing efficiency within a facility. For example, the dashboard interface may show past reports, real time reports, a number of individuals or identity of individuals making reports, etc. One of ordinary skill will recognize additional information which may be provided in the dashboard interface.

In these various embodiments, the various reports, information gathering, dashboard interface, and other system components may be customizable to user requirements. In a further embodiment, the user may be provided with one or more customizable templates for configuring the reports, dashboard, etc. The templates may be selected by the user from a library of preconfigured templates. Alternatively, the user may be provided with a template generator interface for generating his or her own templates for subsequent use. Additionally, the user may be provided with a template editor for customizing the templates to generate customized reports or dashboards.

One of ordinary skill in the art will recognize that the various modules, engines, processors, interfaces, and generators described in FIGS. 2-3 may be implemented as discrete hardware modules. Alternatively, these elements of the server 117 may be implemented modules of processor operation defined by processor-executable code which is stored on a data storage device or other tangible computer readable medium. One of ordinary skill in the art will recognize that execution of such processor-executable code by one or more data processors will cause the one or more data processors to operate as a special purpose machine configured for execution of the operations defined in the code.

For example, operations as defined in a computer-executed method illustrated in FIG. 4 may be carried out by such a device. FIG. 4 is a schematic flowchart diagram illustrating one embodiment of a method 400 for triggering a record of a PREA incident. In an embodiment, the method 400 starts, when the reporting interface 201 receives information concerning an inmate in a controlled facility over a facility communications system that is related to an act of sexual misconduct as illustrated at block 401. The reporting engine 203 may then automatically trigger an event in response to receiving the information. The reporting engine 203 may then generate a record comprising at least a portion of the information related to the act of sexual misconduct in a data storage device.

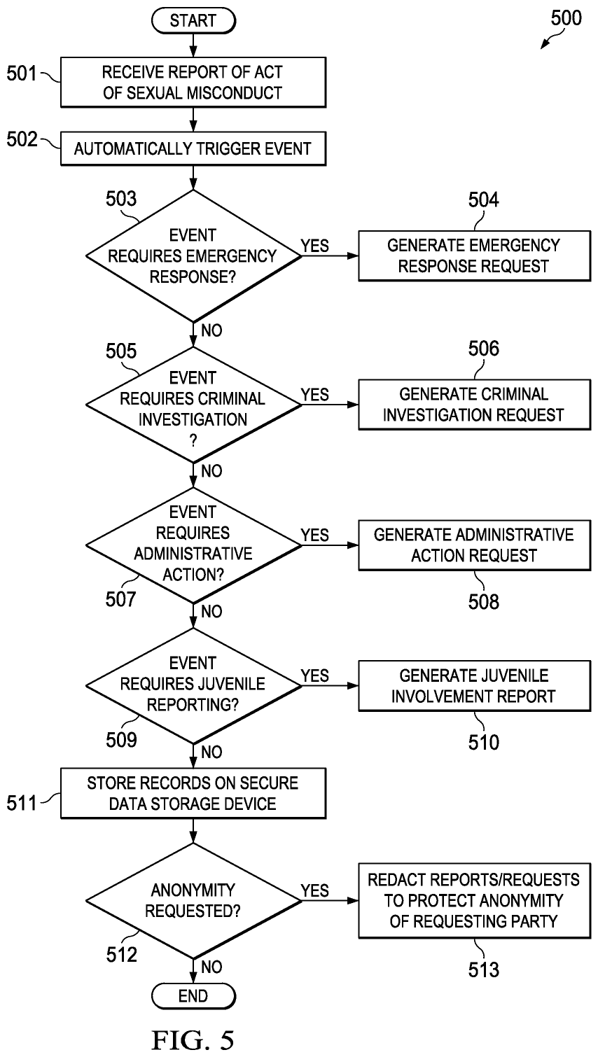

FIG. 5 illustrates another embodiment of a method 500 for triggering a record of a PREA incident. In such an embodiment, the method 500 starts when the reporting interface 201 receives a report of an act of, for example, sexual misconduct as illustrated at block 501. The reporting engine 203 may then automatically trigger an event as shown at block 502. In an embodiment, the method may include automatically scheduling one or more response deadlines in response to the time at which the event is triggered. In an embodiment, the reporting engine 203 may require a responsive communication in response to the triggered event, and escalate the event to a superior in response to a determination that the responsive communication has not been received by the response deadline.

In response to the event at block 502, the reporting engine 203 may determine whether the event requires an emergency response as illustrated at block 503, criminal investigation as illustrated at block 505, administrative action as illustrated at block 507, and/or juvenile reporting as illustrated at block 509. If the reporting engine determines that any of these reports are required, the appropriate report may be generated by a sub-unit. For example, the emergency response report generator 308 may generate an emergency response request as illustrated at block 504. In another embodiment, the criminal report generator 309 may generate a criminal investigation request as illustrated at block 506. In a further embodiment, the administrative report generator 310 may generate, among other reports, an administrative action request as shown at block 508. Additionally, the juvenile report generator 311 may generate a juvenile involvement report as illustrated at block 510.

In each such instance, the received information and any associated reports and/or requests may be stored on a secure data storage device as illustrated at block 511. In a particular embodiment, the data security manager 314 may encrypt the records to ensure security of the data stored on the secure data storage device. Additionally, if the anonymity manager 315 determines that anonymity has been requested by any involved party as shown at block 512, then the anonymity manager 315 may redact reports/requests to protect the anonymity of the requesting party as shown at block 513.

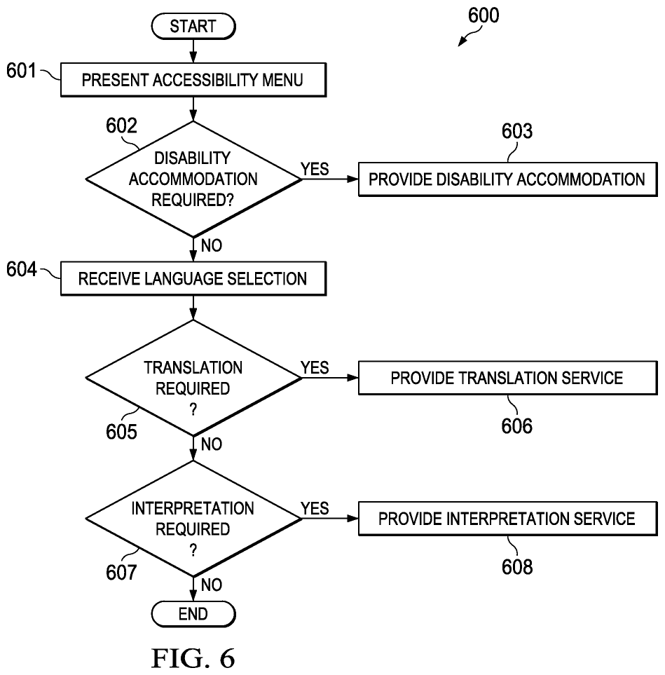

FIG. 6 is a schematic flowchart diagram illustrating one embodiment of a method 600 for providing accessibility to a party reporting an act of misconduct. In one embodiment, the method 600 starts when the accessibility interface 202 presents an accessibility menu as illustrated at block 601. In response to a user input, the accessibility interface 202 may determine whether any disability accommodation is required as illustrated at block 602. If so, then the disability interface 307 may provide the required disability accommodation, or cooperate with required disability accommodation equipment as shown at block 603.

If a language selection is made, then the language selection interface 304 may receive the language selection as illustrated at block 604. If the accommodation interface 202 determines that translation or interpretation is required as shown at blocks 605 and 607 respectively, then the translation interface 305 and/or the interpretation interface 306 may provide translation services and/or interpretation services as shown at blocks 606 and 608 respectively.

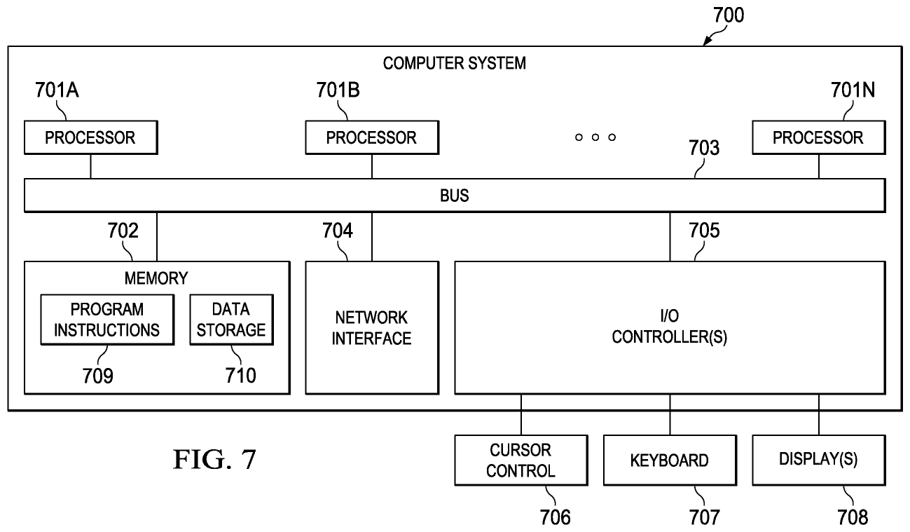

FIG. 7 is a schematic block diagram illustrating one embodiment of a computer system 700 configured for use according to the present embodiments. In one embodiment, crime server 117 may be implemented on a computer system similar to the computer system 700 described in FIG. 7. Similarly, kiosk 103 may be implemented on a computer system similar to the computer system 700 described in FIG. 7. Detention facility call processing system 101 may also be implemented on a computer system similar to the computer system 700. In various embodiments, computer system 700 may be a server, a mainframe computer system, a workstation, a network computer, a desktop computer, a laptop, or the like.

As illustrated, computer system 700 includes one or more processors 701A-N coupled to a system memory 702 via bus 703. Computer system 700 further includes network interface 704 coupled to bus 703, and input/output (I/O) controller(s) 705, coupled to devices such as cursor control device 706, keyboard 707, and display(s) 708. In some embodiments, a given entity (e.g., server 117) may be implemented using a single instance of computer system 700, while in other embodiments multiple such systems, or multiple nodes making up computer system 700, may be configured to host different portions or instances of embodiments (e.g., server 117).

In various embodiments, computer system 700 may be a single-processor system including one processor 701A, or a multi-processor system including two or more processors 701A-N (e.g., two, four, eight, or another suitable number). Processor(s) 701A-N may be any processor capable of executing program instructions. For example, in various embodiments, processor(s) 701A-N may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processor(s) 701A-N may commonly, but not necessarily, implement the same ISA. Also, in some embodiments, at least one processor(s) 701A-N may be a graphics processing unit (GPU) or other dedicated graphics-rendering device.

System memory 702 may be configured to store program instructions and/or data accessible by processor(s) 701A-N. For example, memory 702 may be used to store software program and/or database shown in FIGS. 4-6. In various embodiments, system memory 702 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 702 as program instructions 709 and data storage 705, respectively. In other embodiments, program instructions and/or data may be received, sent or stored upon different types of computer-accessible media or on similar media separate from system memory 702 or computer system 700. Generally speaking, a computer-accessible medium may include any tangible, non-transitory storage media or memory media such as electronic, magnetic, or optical media—e.g., disk or CD/DVD-ROM coupled to computer system 700 via bus 703, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 703 may be configured to coordinate I/O traffic between processor 701, system memory 702, and any peripheral devices including network interface 704 or other peripheral interfaces, connected via I/O controller(s) 705. In some embodiments, bus 703 may perform any necessary protocol, timing or other data transformations to convert data signals from one component (e.g., system memory 702) into a format suitable for use by another component (e.g., processor(s) 701A-N). In some embodiments, bus 703 may include support for devices attached through various types of peripheral buses, such as a variant of the Peripheral Component Interconnect (PCI) bus standard or the Universal Serial Bus (USB) standard, for example. In some embodiments, the operations of bus 703 may be split into two or more separate components, such as a north bridge and a south bridge, for example. In addition, in some embodiments some or all of the operations of bus 703, such as an interface to system memory 702, may be incorporated directly into processor(s) 701A-N.

Network interface 704 may be configured to allow data to be exchanged between computer system 700 and other devices, such as other computer systems attached to server 117, for example. In various embodiments, network interface 704 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 705 may, in some embodiments, enable connection to one or more display terminals, keyboards, keypads, touch screens, scanning devices, voice or optical recognition devices, or any other devices suitable for entering or retrieving data by one or more computer system 700. Multiple input/output devices may be present in computer system 700 or may be distributed on various nodes of computer system 700. In some embodiments, similar I/O devices may be separate from computer system 700 and may interact with computer system 700 through a wired or wireless connection, such as over network interface 704.

As shown in FIG. 7, memory 702 may include program instructions 709, configured to implement certain embodiments described herein, and data storage 705, comprising various data accessible by program instructions 709. In an embodiment, program instructions 709 may include software elements of embodiments illustrated in FIGS. 4-6. For example, program instructions 709 may be implemented in various embodiments using any desired programming language, scripting language, or combination of programming languages and/or scripting languages. Data storage 705 may include data that may be used in these embodiments such as, for example, server 117. In other embodiments, other or different software elements and data may be included.

A person of ordinary skill in the art will appreciate that computer system 700 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

Embodiments of server 117 described in FIGS. 1-3 may be implemented in a computer system that is similar to computer system 700. In one embodiment, the elements described in FIGS. 1-3 may be implemented in discrete hardware modules. Alternatively, the elements may be implemented in software-defined modules which are executable by one or more of processors 701A-N, for example.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

1. A method for operation of an automated report system, the comprising:
generating an automated report of sexual misconduct concerning an inmate of a controlled-environment facility, wherein the report is generated via a user interface of an inmate device provided by the controlled-environment facility, wherein an option for reporting sexual misconduct by an inmate is included in the user interface, wherein selection of the user interface option for reporting sexual misconduct by an inmate identified as having misused the option for reporting sexual misconduct is routed to the automated report, and wherein the report comprises a plurality of user selections from the user interface;
generating a recording of the report, wherein the recording comprises the plurality of selections from the user interface;
marking the generated recording as reported evidence of an investigation into the reported sexual misconduct, wherein the marked evidence comprises the plurality of selections from the user interface;
generate the investigation in response to the report and marking the generated recording; and
generating a record in a data storage device, the record comprising at least a portion of the marked recording of the report of sexual misconduct.

2. The method of claim 1, further comprising receiving the report from the inmate device configured to allow the report to be generated anonymously.

3. The method of claim 2, wherein the inmate device comprises one of a video visitation system, a telephone communication system, an email communication system, a kiosk communication system, or a tablet device.

4. The method of claim 1, further comprising determining the need for accessibility services by a user of the inmate device reporting the act of sexual misconduct.

5. The method of claim 4, wherein providing the accessibility services further comprises providing a language selection control to the inmate reporting the act of sexual misconduct.

6. The method of claim 5, further comprising providing translation services in response to a language selection via the language selection control.

7. The method of claim 5, further comprising providing interpretation services in response to a language selection via the language selection control.

8. The method of claim 4, further comprising providing the language accessibility services by adjusting the plurality of selections provided by the user interface.

9. The method of claim 1, further comprising:
determining whether the act of sexual misconduct requires emergency response; and
generating a report to an emergency responder requesting assistance at the scene of the incident.

10. The method of claim 1, further comprising:
generating a report to an investigator requesting investigation of the act of sexual misconduct.

11. The method of claim 1, further comprises generating a notification in the form of an email, text, or phone call.

12. The method of claim 2, wherein all uses of the inmate device other than generating a report of sexual misconduct requires identification of an individual requesting use of the inmate device.

13. The method of claim 1, further comprising the sexual misconduct taking place in the controlled-environment facility or in another controlled-environment facility.

14. The method of claim 1, further comprising:
determining whether administrative action is required in response to the report of the act of sexual misconduct; and
generating a report to an administrator requesting action in response to the act of sexual misconduct.

15. The method of claim 14, wherein the action comprises conducting a physical transfer of the victim of the act of sexual misconduct to a new location.

16. The method of claim 14, wherein the action comprises removing or reassigning of staff from the victim.

17. The method of claim 14, wherein the action comprises investigation of staff of the controlled-environment facility.

18. The method of claim 1, further comprising:
determining whether the act of sexual misconduct involves a juvenile; and
generating a report to a juvenile services organization to report the act of sexual misconduct.

19. The method of claim 1, further comprising automatically scheduling one or more response deadlines in response to the time at which the investigation is triggered.

20. The method of claim 19, further comprising:
requiring a responsive communication in response to the triggered investigation, and escalating the investigation to a superior in response to a determination that the responsive communication has not been received by the response deadline.

21. The method of claim 1, further comprising storing the information received in a secure storage device.

22. The method of claim 1, further comprising protecting the anonymity of a party involved in the incident, the nature of the reporting or reporting of the incident in response to a request for anonymity.

23. The method of claim 1, further comprising generating a dashboard interface configured to provide a snapshot of compiled information.

24. A non-transitory tangible computer readable medium of an automated report system comprising processor-executable code that, when executed by a processor, causes the processor to perform operations comprising:
receiving, at a crime server, an automated report of sexual misconduct concerning an inmate of a controlled-environment facility, wherein the report is received via an inmate device provided by the controlled-environment facility, wherein the report is received from a user interface of the inmate device, and wherein an option for reporting sexual misconduct by an inmate is included in the user interface, wherein selection of the user interface option for reporting sexual misconduct by an inmate identified as having misused the option for reporting sexual misconduct is routed to the automated report system, and wherein the report comprises a plurality of user selections from the user interface;
generating a recording of the received report, wherein the recording comprises the plurality of selections from the user interface;
marking the generated recording as reported evidence of an investigation into the reported sexual misconduct, wherein the marked evidence comprises the plurality of selections from the user interface;
generate the investigation in response to receiving the report and marking the generated recording; and
generating a record in a data storage device, the record comprising at least a portion of the marked recording of the report of sexual misconduct.

25. An automated report system comprising:
one or more inmate devices provided by a controlled-environment facility in electronic communication with a crime reporting server, wherein the inmate devices provide residents of the controlled-environment facility with monitored communication services with a restricted plurality of non-residents, wherein the one or more inmate devices comprise a user interface comprising a plurality of selections for use of the provided communication services, wherein an option for reporting sexual misconduct is included in the user interface, and wherein selection of the user interface option for reporting sexual misconduct by an inmate identified as having misused the option for reporting sexual misconduct is routed to the automated report system; and
a crime reporting server coupled to the one or more inmate devices and configured to:
receive a report of sexual misconduct concerning an inmate of the controlled-environment facility, wherein the report is received from one of the one or more inmate devices, wherein the report is generated using the user interface of the inmate device, and wherein the report comprises a plurality of user selections from the user interface;
generate a recording of the received report, wherein the recording comprises the plurality of selections from the user interface;
mark the generated recording as reported evidence of an investigation into the reported sexual misconduct, wherein the marked evidence comprises the plurality of selections from the user interface;
generate the investigation in response to receiving the report and marking the generated recording; and
generate a record in a data storage device, the record comprising at least a portion of the marked recording of the report of sexual misconduct.
